(19) United States
(12) Patent Application Publication
(10) Pub. No.: US 2026/0008333 A1
(43) Pub. Date: Jan. 8, 2026

(54) Cleanable Chaff Screen for Outdoor Equipment Grilles

(71) Applicants: Alicia Lynn Tennery, Elk City, OK (US); Oren Slade Tennery, Elk City, OK (US)

(72) Inventors: Alicia Lynn Tennery, Elk City, OK (US); Oren Slade Tennery, Elk City, OK (US)

(21) Appl. No.: 18/765,291

(22) Filed: Jul. 7, 2024

(51) Int. Cl. B60K 11/08; B60R 19/52

(52) U.S. Cl. CPC B60K 11/08; B60R 19/52; B60Y 2200/221; B60Y 2200/222

(57) ABSTRACT

A chaff screen for outdoor equipment has an edge or frame which is conformable to a periphery of a grille, a set of louvers, or a vent of a unit of outdoor equipment, with mesh affixed across the edge or frame, in which the mesh has a high filament count, small aperture size, and an anti-static component or treatment, and having one or more fasteners to attach the edge or frame and mesh to the unit of outdoor equipment.

### INCORPORATION BY REFERENCE

Patent Cooperation Treaty (PCT) patent application WO2001081000A1, published on Nov. 1, 2001, by J. Fagan Micheal, et al.; Japanese published patent application JPS6216145A filed on Jul. 15, 1985, by Susumu Ueno, et al.; and Japanese patent JP4726318B2 filed by K B Seiren Lt. on Mar. 30, 2001, are all incorporated by reference herein, including drawings.

### FIELD OF THE INVENTION

This invention relates to screens to prevent chaff from adhering to and/or clogging components of outdoor equipment, such as but not limited to tractors, mowers, combines, harvesters, generators, sawmills, air conditioner outside units, heat pump outside units, and heat exchangers.

### BACKGROUND OF THE INVENTION

Some outdoor power equipment are essentially “open frame” such that their power plant, be it an internal combustion engine (ICE) or an electric motor, is not shrouded or enclosed. Such open frame outdoor power equipment allows maximum air flow to cool the power plant and maximum accessibility to service the power plant (e.g., adjust choke, check oil, etc.), but also provides only minimal protection from the elements (e.g., weather, debris) and minimum operator safety (e.g., operator can come in contact with hot or dangerous moving parts).

Many models of outdoor power equipment, however, are “closed frame” such that the power plant is enclosed by one or more body and frame components, such as but not limited to hoods, louvers, grilles, fenders, panels, screens, doors and housings. Because outdoor power equipment power plants often require a flow of air to cool them, these closed frame components are often provided with protective ventilation elements to allow air into the enclosed power plant volume, such as vents, screens, meshes, and patterns of holes, but also to prevent larger items such as insects, user's fingers, etc., from entering the enclosed volume for the power plant. While some outdoor power equipment is passively air-cooled, other models are actively air-cooled using one or more fans to move a greater amount of air through the ventilation elements.

### SUMMARY OF THE INVENTION

A chaff screen for outdoor equipment is disclosed which has a frame or edge that is conformable to a periphery of a grille, set of louvers, or vent of a unit of outdoor equipment, with a high filament thread count, small aperture mesh affixed across the frame, and having one or more fasteners to attach the frame or the edge with the mesh to the unit of outdoor equipment.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 provides an exploded isometric view according to at least one embodiment of the present invention.

FIG. 2 illustrates a flattened view according to at least one embodiment of the present invention.

FIG. 3 depicts a manner of use from an isometric view of a closed-frame tractor according to at least one embodiment of the present invention.

FIG. 4 shows a front view of the exampled manner of use of FIG. 3.

FIG. 5 shows example chaff capture according to at least one embodiment of the present invention.

FIG. 6 shows a typical closed-frame stand-by generator.

FIG. 7 illustrates a second example embodiment according to the present invention as configured for use on a typical closed-frame stand-by generator.

FIG. 8 shows a common air conditioning outdoor unit.

FIG. 9 shows typical clogging of an ordinary air conditioning unit by chaff, without the benefit of a screen according to the present invention.

FIG. 10 illustrates required disassembly to properly clean a chaff-clogged outdoor air conditioning unit, without the benefit of a screen according to the present invention.

FIG. 11 depicts tedious precise cleaning required for a chaff-clogged outdoor air conditioning unit, without the benefit of a screen according to the present invention.

FIG. 12 shows another example embodiment according to the present invention as utilized with and configured for an air conditioning system outside unit.

FIG. 13 illustrates another example embodiment according to the present invention as utilized with and configured as a bungee-cord attached screen on a typical utility tractor.

### DESCRIPTION OF ONE OR MORE EXAMPLE EMBODIMENTS ACCORDING TO THE INVENTION

It is well-known by users of various closed-frame outdoor power equipment including, but not limited to, tractors, mowers, combines, harvesters, generators, and sawmills, that chaff can clog conventional grilles, vents, holes and screens, which severely reduces the operation of their radiators. Other outdoor equipment, such as air conditioning and heat pump (HVAC) outdoor units as well as outdoor heat exchangers, also draw air over structures that are similar to radiators of outdoor power equipment. All of these types of equipment are susceptible to drawing and and clogging with chaff. For the purposes of this disclosure, we will refer collectively to various closed-frame outdoor power equipment including, but not limited to, tractors, mowers, combines, harvesters, generators, and sawmills, as well as outdoor HVAC units and heat exchangers as “outdoor equipment”.

Additionally, for our purposes in this disclosure, we will use the term “chaff” to refer to any organic material such as grass clippings, shreds of plant materials from crops, saw dust, husks of grains, air-borne seeds and seed pods, shreds of grass, cut up straw, fodder, leaves, and membranous brittle bracts of the flowers of certain plants. Chaff, as the term is commonly used, is usually very dry in nature such that it can readily blow in the wind, rise from the earth, or fall from trees, reaching the grilles, louvers, and/or vent elements of outdoor equipment, where the chaff becomes trapped or attached. When grilles and vent elements become clogged with too much chaff, air flow is sufficiently diminished and overheating of the outdoor equipment can occur.

The present inventors, being frequent users of a tractor-mower rig, became well acquainted with the loss of time and energy to stop and clean out the chaff clogging the tractor's grille. The present inventor began to search for solutions to this available in the retail market, and found only videos of other outdoor equipment users explaining how they cleaned their grilles and vents. This included a wide variety of tools to pry the chaff out of the offices in the grilles and vents, and various ways of using pressurized water to blast the chaff free, none of which are quick or conducive to performing while “out in the field”, thereby causing even greater delay and waste of time.

While the standard metal and plastic grills and vent elements of closed-frame outdoor equipment provide excellent protection of the power plant from incursion of foreign matter such as sticks and branches, and they provide protection of the user from accidental contact with dangerous moving or hot components, the present inventors realized the unmet needs in the art to prevent clogging from chaff or, in the alternative, to make removal of chaff quicker and easier to do while “in the field” without having to return to a barn, pressurized water source, or maintenance facility.

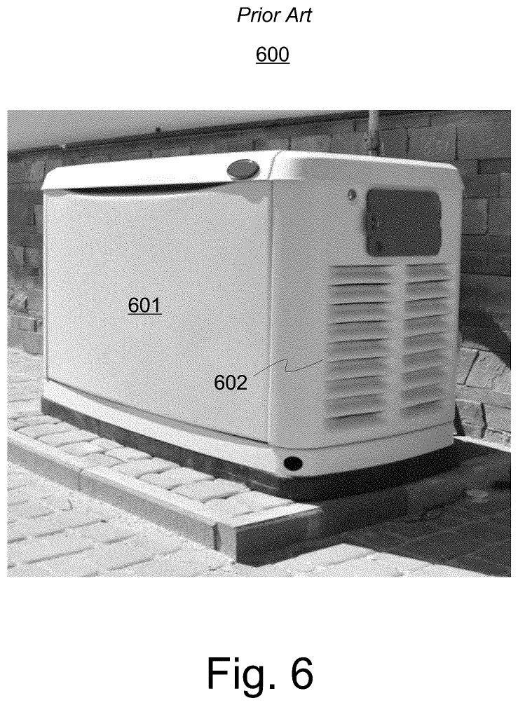

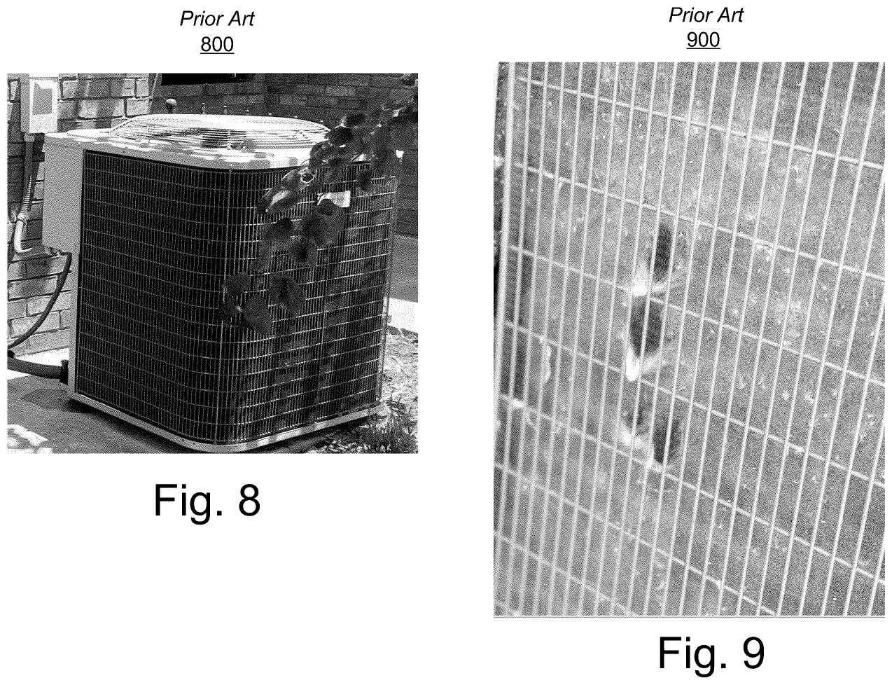

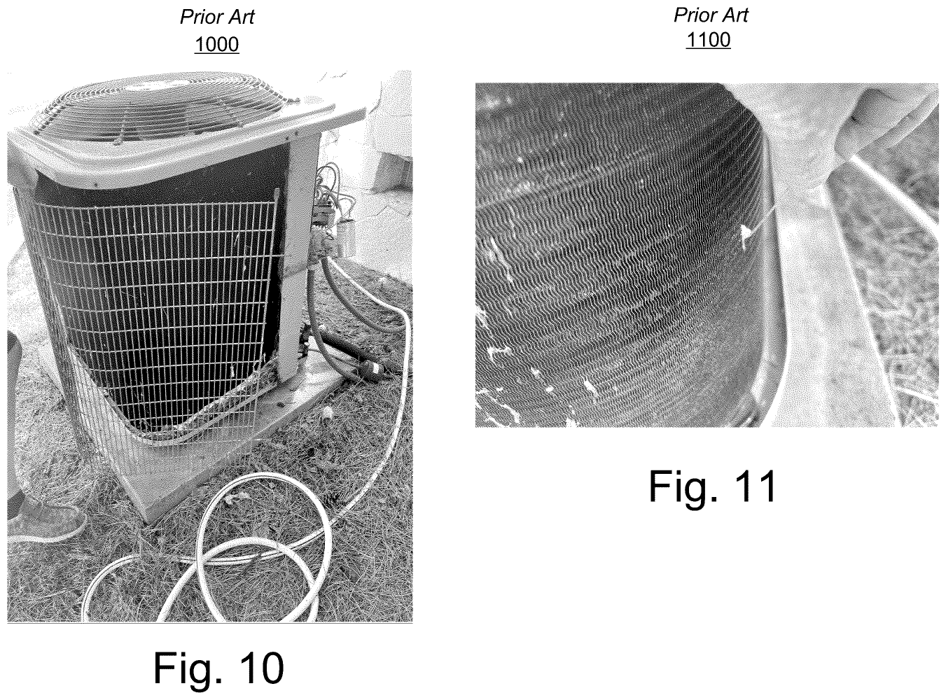

For example, a common closed-frame backup generator shown 600 in FIG. 6 includes a set of louvers 602 to allow air into the enclosure to cool the internal combustion engine house within the enclosure. These louvers are susceptible to being clogged by chaff. A common outdoor unit of an air conditioning (HVAC) system shown 800 in FIG. 8 also has small fins and a fan to draw outside air through the heat exchanger coils, similar to an internal combustion engine's radiator. These coils and fins are susceptible to clogging from chaff, such as cottonwood seed, as shown 900 in FIG. 9. Cleaning and restoring the outside HVAC unit to full functionality requires careful disassembly, as shown 1000 in FIG. 10, to avoid bending, smashing or damaging these thin fins. And, material stuck between the fins may require time-consuming, tedious and meticulous effort to remove, such as using a small probe (e.g., toothpick) to pick it out, fin by fin.

Still further, the present inventors were unable to find any suitable and effective device or system for small and medium size outdoor equipment, such as residential tractor mowers and residential generators. While some very high-end farm equipment has optional screen-cleaning functions, such as reversing fans and rotating barrel screens, these elaborate mechanisms are not cost-effective for small and medium size outdoor equipment, nor are the readily retrofittable to common outdoor equipment models.

For these reasons, the present inventors set out to research, experiment, and design a new, cost-effective, practical and easy-to-use retrofittable chaff screen that can be readily cleaned without the need for special tools, pressurized water or pressurized air, while the power equipment is still in it's intended environment of use, such as a field, forest, trail, etc.

### A First Example Embodiment

While the first embodiment disclosed herein is readily retrofittable, those ordinarily skilled in the art will realize that the components and materials may also be fitted by original equipment manufacturers (OEMs) during initial assembly, and that certain variations of the embodiment may be produced and offered as after-market accessories for specific makes and models of outdoor equipment.

Further, those ordinarily skilled in the art will realize that, although a shape, size, and arrangement of components is disclosed relative to a specific make and model of tractor, the present invention may be realized in other shapes, dimensions and arrangement of components for other tractors as well as for other closed-frame outdoor equipment makes and models.

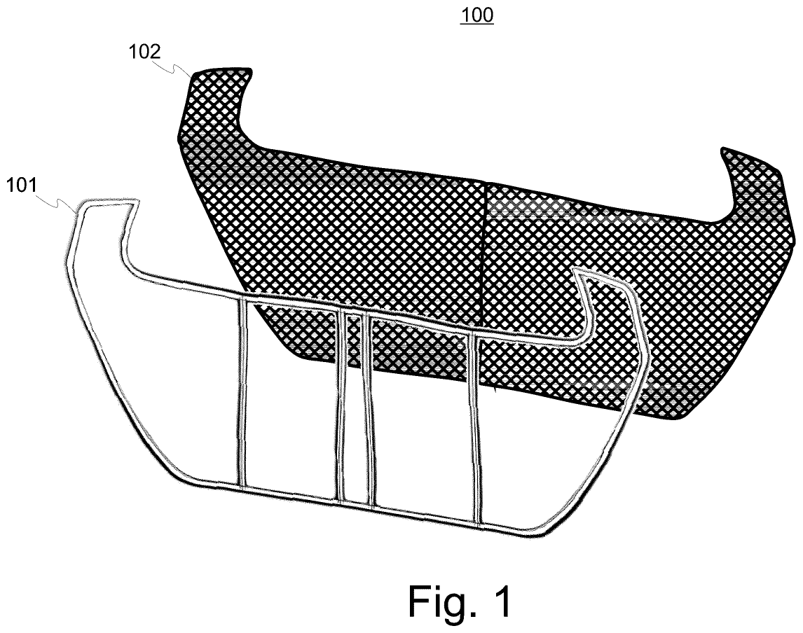

Referring now to FIG. 1, an example embodiment according to the present invention is shown tailored specifically for a John Deere model 3720 utility tractor which has a nominal 40 hp ICE and a PTO (power take off) lift capacity of about 2250 lbs. It is a closed frame tractor, having a hood that surrounds the ICE power plant. This exploded view 100 of this example embodiment shows two main components of the retrofittable, easily-cleaned chaff screen, the first of which is a peripheral frame 101 and the second of which is a screen material 102, both of which are formed by cutting, shaping, molding, bending, or some combination thereof, to match the shape and outline of the specific tractor's grille. The frame 101 and chaff screen material 102 are affixed to each other, and the combined unit 100 is attached to the tractor in a manner to cover and protect the entire grille and ventilation elements.

Through experimentation and a process of deduction and elimination, the present inventors have found frame and chaff screen materials which are suitable for this particular embodiment, and which run counter to conventional wisdom. Conventional wisdom holds that the gaps or spaces in the grille or vent must be as large as possible to allow for the greatest possible air flow while also providing a strong enough structure to withstand reasonable impacts from branches, stalks, tools, animals, etc. In practice, these conventional grille, vent an louver gap sizes are so large that chaff can pass through and clog fans and fins of heat exchangers, thus the problem addressed by the present inventors remains unsolved.

Another element of conventional wisdom as that filters and pre-filters which are intended to capture smaller particles must be static-charged in order to work. Static-charged filters use materials which attract and hold smaller particles using static differences between the filter and the particles, but they tend not to be easy to clean, and most often, are disposable. The present inventors found that static-charged materials were unsuitable for chaff screens because the amount of chaff stirred up during a typical dry-season mow would quickly fill and clog such material. As such, using a static-charged screen material did not work for this application, despite conventional wisdom teaching in this direction.

The present inventors found that, unexpectedly, a very fine mesh with an anti-static property of the material worked very well. This defied conventional wisdom in two ways. First, whereas conventional wisdom teaches that small screen openings would reduce air flow too much, the present inventors found that this air flow restriction can be offset by using a mesh material in which the strand width is very small (e.g., fine) because this chaff screen is not intended to be or required to be the strong barrier to prevent incursion into the enclosed power plant volume. The pre-existing grille or vents may be kept and used for this purpose.

Second, the present approach defies conventional wisdom by not using static-charged or a neutral (e.g., “grounded”) screen material, but instead, by using anti-static material. Anti-static material is material which has been manufactured or treated to have properties which reduce static electricity and reduce static attraction between the mesh material and the intended particles to be screened. Reducing rather than increasing static attraction is counter to general approaches in particulate filtering.

The present inventors believe that the anti-static material works better than expected for the particular application because chaff is generally already static-charged, possibly from its very dry organic nature, and possibly from the mechanical action of cutting the plants by metal blades. For example, Patent Cooperation Treaty (PCT) patent application WO2001081000A1, published on Nov. 1, 2001, by J. Fagan Micheal, et al., describes a coffee bean grinder which reduces chaff dispersion by introducing negatively-charged ions into the output chute flow of the ground coffee which has been positively-charged by the metal grinding discs or blades. The present inventors believe that, despite conventional wisdom otherwise, the use of anti-static mesh material actually prevents (instead of enhancing) the chaff from becoming clung to or stuck to the mesh, which enables the user to simply wipe or brush away the chaff to restore air flow and continue using the tractor or other outdoor equipment, without the need for tools, scrapers, brushes, or pressurized water or air.

Through experimentation, the present inventors found that certain meshes normally utilized for screen printing performed very well as a cleanable chaff screen. Most screen printing mesh is made with synthetic strands or filaments, and most are already fabricated or coated with anti-static elements such as carbon. Mesh count is the measure of how many threads cross each other in a unit of square area, such as a square inch. Higher mesh count meshes have more threads, more intersections, and more gaps than meshes with lower thread counts, and the threads or filaments themselves are thinner (finer, smaller diameter). Meshes with higher thread counts support finer detail and precision in printing, while meshes with lower thread counts support thicker inks and printing on rougher surfaces.

The present inventors found that screen printing meshes with 60 polyester threads per square inch or greater and with an anti-static treatment formed in the threads or applied to the threads worked very well for the objectives of this invention. Such meshes had an aperture of 1 mm or less between its filaments. Lower thread counts did not perform as well, and while potentially helpful, were not considered by the present inventors to meet the objectives of the invention.

Japanese published patent application JPS6216145A filed on Jul. 15, 1985, by Susumu Ueno, et al., describes a polyester thread mesh of line widths of 250 mum or less with an anti-static agent additive. Japanese patent JP4726318B2 filed by K B Seiren Lt. On Mar. 30, 2001, describes how to render several anti-static polymers for monofilament fibers. In some embodiments, a fine mesh having holes or gaps of less than 1 mm may be used and a spray-on chemical coating such as “Staticide”™ anti-static treatment available from ACL, Inc., of Chicago, IL, USA, may be applied to the mesh to render the anti-static property as desired. In other embodiments, if the original built-in anti-static characteristic of the chaff mesh appears to “wear off” or lose its effectiveness, a topical coating such as Staticide™ may be applied to the mess to renew its performance.

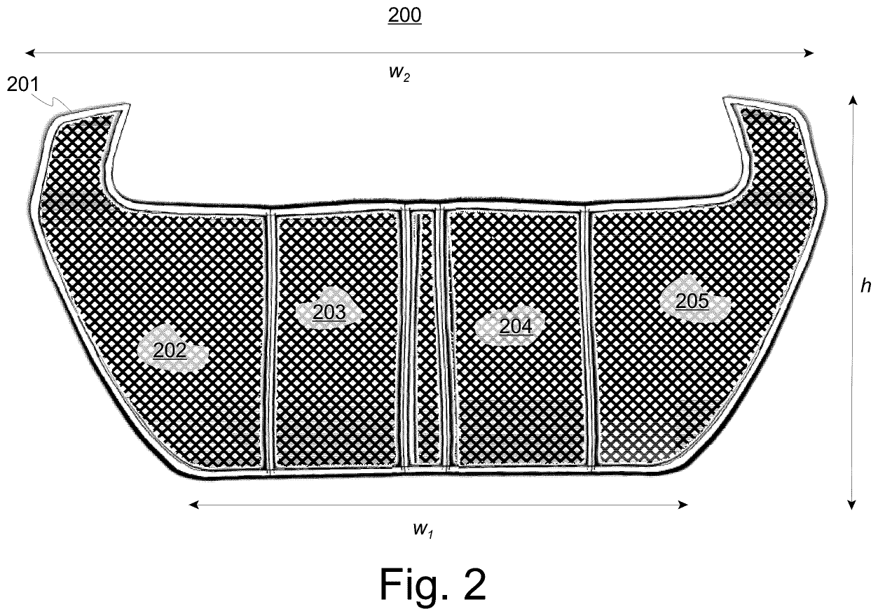

In the example embodiment for use with the example tractor, the frame 101 was fabricated using 30 mil thick Superior Graphic Supplies™ brand magnetic sheet material available from Better Crafts LLC of New York, USA. In one format, it is supplied in rolls 24″ wide and 60″ long, and is cuttable by knife, CNC or stamping to achieve the shape necessary to follow the periphery of the grille and/or vents of a specific make and model of outdoor equipment. Referring now to FIG. 2, in the instant example embodiment, the flattened assembled unit 200 was about w₁=24″ to w₂=31″ wide and about h=17.5″ tall, while other dimensions and shapes are fully within the scope of the present invention for other types, makes and models of outdoor equipment. This particular make and model of tractor had several available metal vertical reinforcement members on the pre-existing grille, extra vertical strips of the magnetic frame material were added to this example embodiment to increase the level of attachment force of the chaff screen 200 to the tractor, yielding several panels or windows of mesh 202, 203, 204 and 205 between the additional vertical strips. Other embodiments may have more or fewer panels, may have horizontal strips of the magnetic frame material, or less frame material, all depending on the specific type, make and model of outdoor equipment to which it is intended to be fitted.

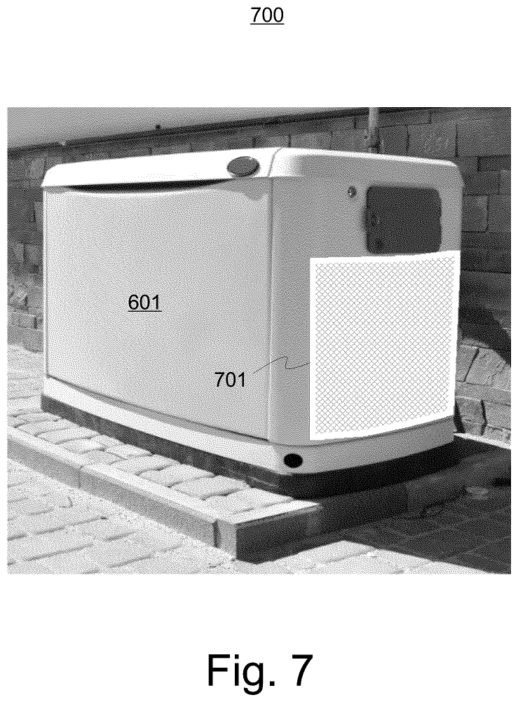

Please note that the diagonal grid shown in FIG. 1, FIG. 2 and FIG. 7 is not showing the mesh density to scale, but rather is indicated the mesh as described herein exists in the marked areas.

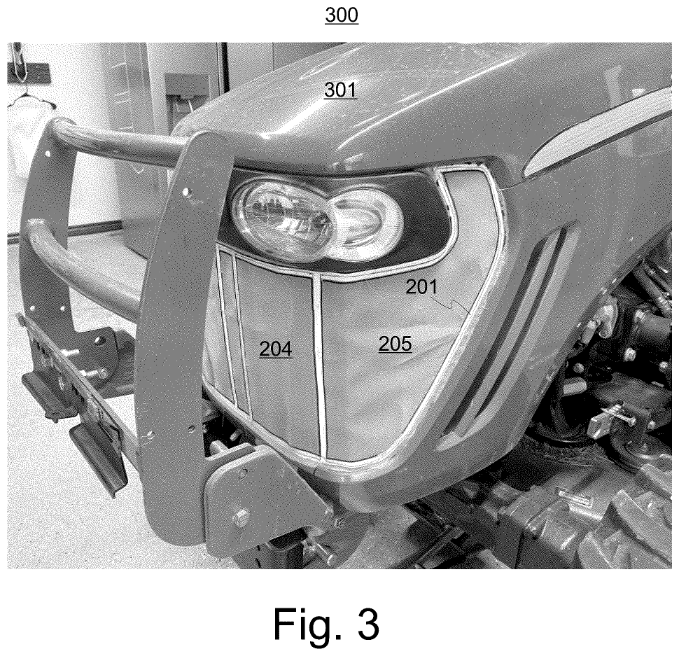

FIG. 3 shows 300 the example embodiment affixed to a tractor 301. From this drawing, it is clearly shown how easily the chaff screen is installed and removed without the use of any tools due to the magnetic attachment of the frame material to the metal of the tractor hood. In other embodiments, the frame may be made of other material, such as nylon, polyester, PVC, metal, fiberglass, etc., and may attach by other means such as by hook-and-loop fastener, double-sided adhesive tape, glue, snaps, zippers, rivets, welding, and other fasteners, all within the scope of the present invention.

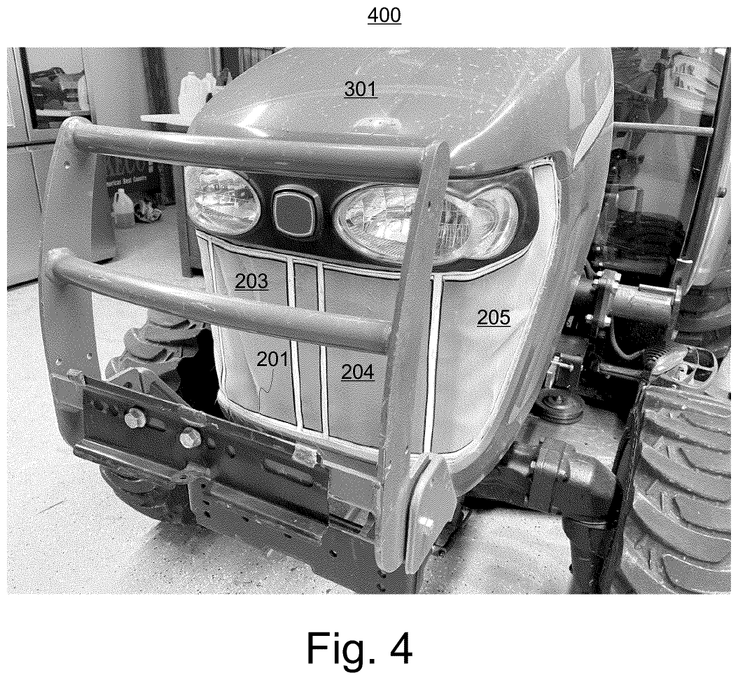

FIG. 4 shows 400 the example embodiment attached to the example tractor of FIG. 3 except from an angled view to see more of the details across the front of the tractor of the fit and seal around the pre-existing grille.

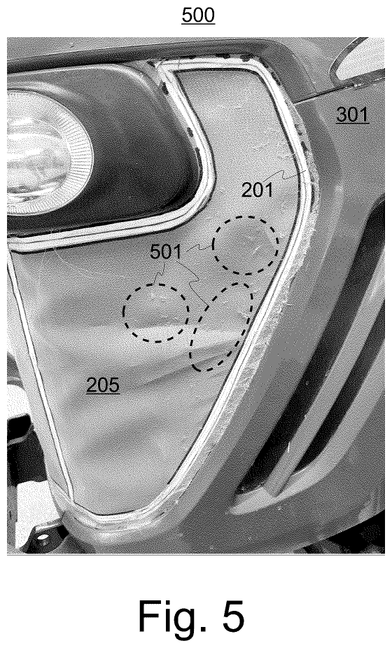

FIG. 5 demonstrates 500 the anti-static (or non-static) capture of some chaff 501 after a small amount of use of the tractor for mowing. Because the mesh openings are smaller than the chaff particles, the chaff is not allowed through the mesh nor does it embed into the mesh between the filaments. Instead, it may stay on the outside surface of the mesh while the engine fan is pulling air through the mess, but when the engine is stopped or upon simple brushing of the mesh, the chaff simply falls off as it is not statically-attracted to the mesh.

### A Second Example Embodiment

FIG. 6 shows 600 an example closed-frame stand-by generator 601 which is typical of a fixed installation. Because it contains an internal combustion engine within the housing, it must have cooling vents 602 in order to operate correctly. A magnetic frame chaff screen 701 according to the present invention maybe fabricated and installed, as shown 700 in FIG. 7.

### A Third Example Embodiment

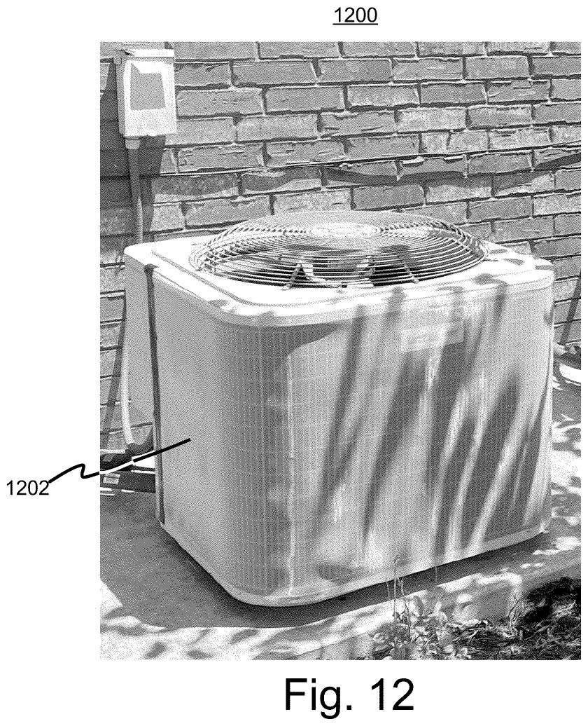

FIG. 12 shows 1200 another example embodiment 1202 according to the present invention as utilized with and configured for an air conditioning system outside unit. The fine mesh screen is overlaid onto the exposed heat exchanger fins and coils, supported by the pre-existing metal grid or grill. Any chaff which is caught by the chaff screen is easily brushed off without the need for high pressure water or air, or special cleaning tools.

### A Fourth Example Embodiment

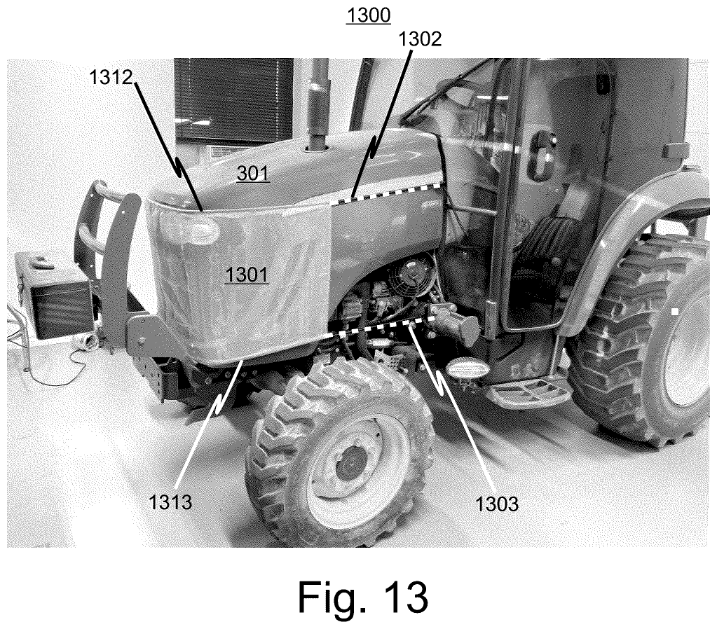

FIG. 13 shows 1300 another

example embodiment 1301 according to the present invention configured with a flexible edge 1312, 1313, sewn to or into the mesh to be strapped using bungee cords 1302, 1303 (illustrated with a dashed white line for contrast against the darker features of the photograph). In one embodiment, a fabric, rubber, or other flexible strip of material is attached, such as by sewing, to one or more edges of the mesh to provide a strong element on which the bungee cords can pull to hold the device tightly against the grille or louver area of the tractor (or other outdoor equipment). In another embodiment, the edge may be formed as a sleeve into which a portion of the bungee cord is disposed, thereby providing the edge and the strong element for the bungees to pull against.

### Conclusion

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The foregoing example embodiments do not define the extent or scope of the present invention, but instead are provided as illustrations of how to make and use at least one embodiment of the invention.

What is claimed is:

1. A chaff screen for outdoor equipment comprising:
one or more edges being conformable to a periphery of a grille, set of louvers, vent, or combination thereof of a unit of outdoor equipment;
a mesh having a plurality of filaments and being affixed across the one or more edges, wherein the mesh has a filament count of at least 60 filaments per square inch;
an anti-static component applied to or contained within the plurality of filaments; and
one or more fasteners configured to attach the edge and mesh to the unit of outdoor equipment.

2. The chaff screen as set forth in claim 1 wherein apertures or gaps between filaments of the mesh are less than 1 mm.

3. The chaff screen as set forth in claim 1 wherein the edge comprises a frame, and wherein the one or more fasteners comprises magnetic material within or affixed to the frame.

4. The chaff screen as set forth in claim 1 wherein the one or more fasteners comprises one or more fasteners selected from the group consisting of a hook-and-loop fastener, a section of double-sided adhesive tape, glue, a snap, a zipper, a rivet, a weld, a screw, a bolt, a magnet, a bungee cord, and an elastic cord.

5. The chaff screen as set forth in claim 1 wherein the unit of outdoor equipment comprises a closed-frame utility tractor.

6. The chaff screen as set forth in claim 1 wherein the unit of outdoor equipment comprises a closed-frame generator.

7. The chaff screen as set forth in claim 1 wherein the unit of outdoor equipment comprises a mower.

8. The chaff screen as set forth in claim 1 wherein the unit of outdoor equipment comprises a combine.

9. The chaff screen as set forth in claim 1 wherein the unit of outdoor equipment comprises a harvester.

10. The chaff screen as set forth in claim 1 wherein the unit of outdoor equipment comprises a sawmill.

11. The chaff screen as set forth in claim 1 wherein the unit of outdoor equipment comprises a heating, ventilation and air conditioning (HVAC) outdoor unit.

12. The chaff screen as set forth in claim 1 wherein the unit of outdoor equipment comprises an outdoor heat exchanger.

13. A method of manufacture of a chaff screen for outdoor equipment comprising:
forming an edge from a conformable material, configured to be attached to a periphery of a grille, set of louvers, vent, or combination thereof of a unit of outdoor equipment;
affixing across the edge a mesh across the edge, wherein the mesh has a plurality of filaments with a filament count of at least 80 filaments per square inch;
providing an anti-static component to the filaments of the mesh; and
configuring one or more fasteners to attach the edge and the mesh to the unit of outdoor equipment.

14. The method of manufacture of claim 13 wherein the providing an anti-static component comprises spraying an anti-static component onto the filaments.

15. The method of manufacture of claim 13 wherein the providing an anti-static component comprises disposing an anti-static component into the filaments.

16. The method of manufacture of claim 13 wherein apertures or gaps between filaments of the mesh are less than 1 mm.

17. The method of manufacture of claim 13 wherein the forming of an edge comprises forming a frame, and wherein the configuring of one or more fasteners comprises disposing a magnetic material within or affixed to the frame.

18. The method of manufacture of claim 13 wherein the one or more fasteners comprises one or more fasteners selected from the group consisting of a hook-and-loop fastener, a section of double-sided adhesive tape, glue, a snap, a zipper, a rivet, a weld, a screw, a bolt, a magnet, a bungee cord, and an elastic cord.

19. The method of manufacture of claim 13 wherein the unit of outdoor equipment comprises a specific unit of outdoor equipment selected from the group consisting of a closed-frame utility tractor, a closed-frame generator, a mower, a combine, a harvester, a sawmill, a heating, ventilation and air conditioning (HVAC) outdoor unit, and an outdoor heat exchanger.
